(19) United States
(12) Patent Application Publication
(10) Pub. No.: US 2010/0318394 A1
(43) Pub. Date: Dec. 16, 2010

(54) EXECUTING TRANSACTIONS AS AN ATOMIC UNIT

(75) Inventors: Tapas K. Nayak, Hyderabad (IN); Anil Prasad, Hyderabad (IN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/484,477

(22) Filed: Jun. 15, 2009

(51) Int. Cl. G06Q 10/00

(52) U.S. Cl. 705/8

(57) ABSTRACT

Multiple operations of a local transaction are enabled to be performed atomically at a resource. A local transaction scope is invoked that includes multiple transaction operations and a commit operation. A local transaction object is generated that includes a transaction identifier. The transaction identifier is initialized with a unique identification number. The transaction identifier is included in a request message that includes a transaction operation. The request message is transmitted to a web service to be provided to a resource, and a response is received. One or more additional request messages including corresponding operations are also transmitted to the web service, and corresponding response messages are received. A completion protocol message that includes the transaction identifier and a commit instruction or an abort instruction is transmitted to the web service, and a completion type response message is received.

### BACKGROUND

In some situations, it may be desired to perform a group of operations using one or more computer-implemented resources. For instance, in a distributed transaction, a bundle of operations is performed by a group of network hosts. In a typical distributed transaction, a transaction manager coordinates the performance of the bundles of operations by the network hosts, which provide the resources for performing the operations. Atomicity is desired for a distributed transaction, such that either all of the operations are performed or none of them are. In another case, a group of operations may be desired to be performed by a single network host in a non-distributed fashion.

Similarly to the distributed transaction case, atomicity may be desired for the group of operations performed by the host, such that either all of the operations are performed or none of them are.

For example, a banking transaction may include a debit operation and a credit operation that must both be performed, or neither is performed. In such an example, a resource may be configured to perform the debit operation and the credit operation. The operations may be coordinated in an atomic fashion such that both of the debit and credit operations are successfully performed by the resource, or neither of the debit operation and credit operations are performed.

A line of business (LOB) system is a resource that may be computer-based, and is configured to service one or more particular business needs. For example, a LOB system may perform accounting, supply chain management, resource planning, database management and/or further enterprise-related functions. A system integrator may desire to use a LOB system to perform one or more operations of a transaction. Conventional LOB systems may support distributed transactions to varying degrees. For instance, some LOB systems can perform transactions of a distributed transaction that is coordinated by a distributed transaction coordinator. Some other LOB applications, however, do not support performing transactions of a distributed transaction. Such LOB applications may need to be customized to implement atomicity.

Thus, system integrators are faced with the task of attempting to integrate LOB systems that may or may not support distributed transactions. Even when some of the LOB systems do support such integration, the system integrator may elect not to use distributed transactions for various reasons, including desiring to avoid reduced performance. Instead, the system integrator may desire to use transactions that are atomic at individual resources. However, customization is currently required to implement atomicity at individual resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A client is enabled to atomically perform multiple operations of a local transaction at a resource, such as a line of business (LOB) system. A client-side channel interface, a service-side channel interface, and a local transaction scope are provided to enable the operations to be performed atomically. The local transaction scope enables a local transaction to be configured at the client in a less complex and predictable manner. The client-side channel interface and the service-side channel interface implement a transaction protocol between the client and a web service, to bridge the client with the resource, such that operations of the local transaction may be provided to the resource to be performed atomically.

For example, in one implementation, a client-side method for performing a local transaction is provided. A local transaction scope that includes a plurality of transaction operations and a commit operation is invoked. A local transaction object is generated. The local transaction object includes an initial state and a transaction identifier. A request message is generated that includes a first transaction operation of the local transaction scope. An identification number is generated. The transaction identifier is initialized with the identification number. The transaction identifier is included in the request message. The request message is transmitted over a communication channel to a service-side web service to be provided to a line of business (LOB) system. A response message to the request message is received from the communication channel. The response message includes the transaction identifier. The initial state of the local transaction object is changed to an active state.

One or more additional request messages are transmitted over the communication channel to the web service to be provided to the LOB system, each including a corresponding next transaction operation of the local transaction scope and the transaction identifier. One or more additional response messages are received from over the communication channel corresponding to the additional request message(s).

A completion protocol message is generated that includes the transaction identifier and a commit instruction or an abort instruction. The completion protocol message is transmitted to the web service. A completion type response message to the completion protocol message is received from the service-side.

In another implementation, a service-side method for performing a local transaction is provided. A request message is received from a client over a communication channel. The request message includes a transaction identifier and a first transaction operation of a plurality of transaction operations of a local transaction scope. A service-side local transaction object that includes the transaction identifier is generated. A web service starts the transaction in a LOB system, and the first transaction operation is provided to the LOB system. A response indication to the first transaction operation is received from the LOB system. A state of the local transaction object is changed to an active state. A response message is transmitted to the client over the communication channel that includes the response indication and the transaction identifier.

One or more additional request messages may be received from the client, each including the transaction identifier and a corresponding next transaction operation of the local transaction scope to be provided to the LOB system. Each next transaction operation is provided to the LOB system. An additional response message corresponding to each next transaction operation is/are provided to the client.

A completion protocol message is received from the client that includes the transaction identifier and a commit instruction or an abort instruction. The local transaction object is completed in response to the completion protocol indication. The LOB system is instructed to perform the received commit instruction or abort instruction. A completion type indication is received from the LOB system. A completion type response message is transmitted in response to the completion protocol message to the client.

In another implementation, a client-side local transaction system is provided. The client-side local transaction system includes a local transaction scope and a client-side channel interface. The local transaction scope is configured to be invoked by a client. The local transaction scope includes a plurality of transaction operations and a commit operation. The local transaction scope causes a local transaction object to be generated. The local transaction object includes an initial state and a transaction identifier. The local transaction scope is configured to generate a request message that includes a first transaction operation of the local transaction scope. The client-side channel interface is configured to generate an identification number, to initialize the transaction identifier with the identification number, to include the transaction identifier in the request message, and to transmit the request message over a communication channel to a web service to be provided to a line of business (LOB) system. The client-side channel interface is further configured to receive a response message to the request message from the communication channel. The response message includes the transaction identifier. The client-side channel interface is further configured to change the initial state of the local transaction object to an active state.

The client-side channel interface may transmit one or more additional request messages over the communication channel to the web service to be provided to the LOB system. For each request message, the client-side channel interface may receive a corresponding response message from over the communication channel.

The client-side channel interface is further configured to generate a completion protocol message that includes the transaction identifier and a commit instruction or an abort instruction, and to transmit the completion protocol message to the web service. The client-side channel interface is further configured to receive a completion type response message to the completion protocol message from the service-side.

In still another implementation, a service-side local transaction system is provided. The service-side local transaction system includes a service-side channel interface and a LOB interface. The service-side channel interface is configured to receive a request message from a client. The request message includes a transaction identifier and a first transaction operation of plurality of transaction operations of a local transaction scope. The service-side channel interface is further configured to generate a service-side local transaction object that includes the transaction identifier after the first transaction operation is started in a LOB system. The LOB interface is configured to provide the first transaction operation to the LOB system, and to receive a response indication to the first transaction operation from the LOB system. The service-side channel interface is further configured to change a state of the local transaction object to an active state, and to transmit a response message to the client that includes the response indication and the transaction identifier.

The service-side channel interface is further configured to receive one or more additional request messages from the client. Each additional request message includes the transaction identifier and a corresponding next transaction operation of the local transaction scope to be provided to the LOB system. The LOB interface is configured to provide each next transaction operation to the LOB system. The service-side channel interface is configured to transmit an additional response message corresponding to each next transaction operation to the client.

The service-side channel interface is further configured to receive a completion protocol message from the client that includes the transaction identifier and a commit instruction or an abort instruction, and to complete the local transaction object in response to the completion protocol indication. The LOB interface is further configured to instruct the LOB system to perform the received commit instruction or abort instruction, and to receive a completion type indication from the LOB system. The service-side channel interface is further configured to transmit a completion type response message in response to the completion protocol message to the client.

Computer systems and computer program products (stored on a computer readable medium) are also described herein that are capable of performing and/or enabling the methods described above and elsewhere herein, including enabling local transactions to be performed at the client-side and at the service-side, and for implementing further embodiments as described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a transaction system, according to an example embodiment.

FIG. 2 shows a block diagram of a transaction system that is an example of the transaction system shown in FIG. 1, according to an embodiment.

FIG. 3 shows a block diagram of a client-side channel interface that includes a client-side local transaction binding element, according to an example embodiment.

FIG. 4 shows a block diagram of a service-side channel interface that includes a service-side local transaction binding element, according to an example embodiment.

FIG. 5 shows a flowchart for performing a local transaction, according to an example embodiment.

FIG. 6 shows a block diagram of the transaction system of FIG. 2, further illustrating communication signals within the transaction system, according to an example embodiment.

FIG. 7 shows a block diagram of a transaction system that is an example of the transaction system shown in FIG. 2, according to an embodiment.

FIG. 8 shows a block diagram of the transaction system of FIG. 7, further illustrating communication signals within the transaction system, according to an example embodiment.

FIG. 9 shows a flowchart for initiating a local transaction, according to an embodiment.

FIG. 10 shows a block diagram of a local transaction scope, according to an example embodiment.

FIG. 11 shows a block diagram of a local transaction object, according to an example embodiment.

FIG. 12 shows a flowchart for communicating over a transaction channel at a client-side, according to an example embodiment.

FIG. 13 shows a block-diagram of a client-side channel interface, according to an example embodiment.

FIG. 14 shows a flowchart for including a transaction identifier in a request message, according to an example embodiment.

FIG. 15 shows a flowchart for communicating over a transaction channel at a service-side, according to an example embodiment.

FIG. 16 shows a block-diagram of a service-side channel interface, according to an example embodiment.

FIG. 17 shows a block diagram of local transaction object generator generating a service-side local transaction object, according to an example embodiment.

FIG. 18 shows a flowchart for handling a transaction operation failure at the service-side, according to an example embodiment.

FIG. 19 shows a block diagram of the transaction system of FIG. 7, further illustrating communication signals within the transaction system, according to an example embodiment.

FIG. 20 shows a flowchart for completing a local transaction at the client-side, according to an example embodiment.

FIG. 21 shows a flowchart for completing a local transaction at the service-side, according to an example embodiment.

FIG. 22 shows a block diagram of an example computer system that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### II. Example Embodiments

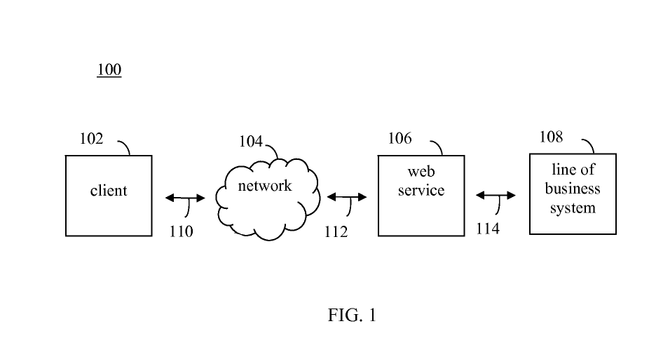

Embodiments of the present invention relate to techniques for atomically performing transactions. Embodiments may be implemented in various environments, including in a web service environment. For example, in such an embodiment, a client may access a resource, such as a line of business (LOB) system, through a web service to perform operations of a transaction atomically. For instance, FIG. 1 shows a block diagram of a transaction system 100, according to an example embodiment. As shown in FIG. 1, system 100 includes a client 102, a network 104, a web service 106, and an LOB system 108. In system 100, client 102 accesses LOB system 108 across network 104 and through web service 106 to perform one or more operations of a transaction atomically. System 100 is further described as follows.

Client 102 may be an application configured to perform one or more functions, including one or more operations that access one or more resources, such as LOB systems. Client 102 may be implemented in hardware, software, firmware, or any combination thereof. For example, client 102 may be implemented as computer program code configured to be executed in one or more processors. Alternatively, client 102 may be implemented as hardware logic/electrical circuitry. For instance, client 102 may be implemented in a computer system, such as a stationary or mobile computing device, including a desktop computer (e.g., a personal computer), a mobile computer (e.g., a personal digital assistant (PDA), a laptop computer, a notebook computer, a smart phone, etc.), or other type of computing device.

Web service 106 and LOB system 108 may be located in a same computer system or separate computer systems. Web service 106 is a web service configured to support interoperable machine-to-machine interaction over network 104, including providing access to LOB system 108 to clients, such as client 102. For example, in an embodiment, web service 106 may be implemented according to the Windows Communication Foundation (WCF) programming framework distributed by Microsoft Corporation of Redmond, Wash., as a WCF service layer. LOB system 108 may be one or more applications configured to perform one or more functions that are accessible by clients. For example, LOB system 108 may be configured to perform one or more of an accounting function, a banking and/or finance-related function, a supply chain management function, a resource planning function, a database management function, and/or any other suitable function. For instance, LOB system 108 may provide enterprise software and/or database functions, including an SQL (structured query language) database, an Oracle® database (distributed by Oracle Corporation of Redwood Shores, Calif.), a Siebel database (distributed by Oracle Corporation), etc.

Computer 102 is shown in FIG. 1 as communicating with web service 106 through network 104 and communication links 110 and 112. For example, as shown in FIG. 1, computer 102 is communicatively coupled with network 104 through a first communication link 110, and web service 106 is communicatively coupled with network 104 through a second communication link 112. LOB system 108 is shown communicatively coupled with web service 106 through a third communication link 114. Network 104 may be a LAN, WAN (wide area network), or combination of networks, such as the Internet. First-third communication links 110a-110c may include any type or combination of communication links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc. In an embodiment where web service 106 and LOB system 108 are located in a same computer system, third communication link 114 may be an inter-computer communication link.

Although a single LOB system 108 is shown in FIG. 1, additional LOB systems may be present in system 100 that are accessible by client 102 through one or more web services 106. Furthermore, although a single client 102 is shown in FIG. 1, multiple clients 102 may be configured to access LOB system 108 through web service 106.

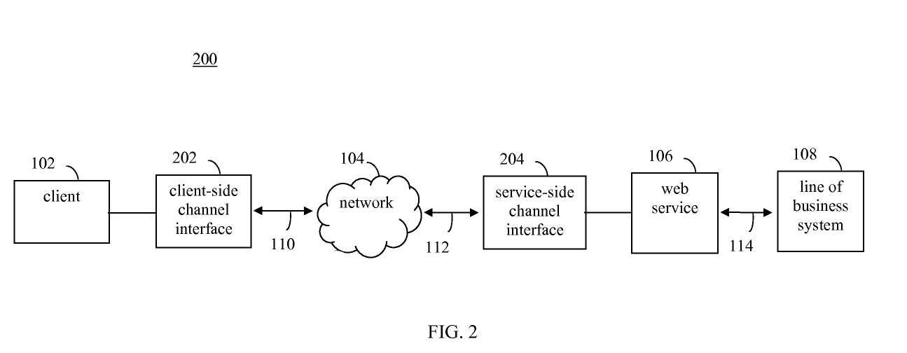

Client 102 and web service 106 may be configured to communicate with each other through network 104 in various ways. For instance, FIG. 2 shows a block diagram of a transaction system 200 that is an example of system 100 shown in FIG. 1, according to an embodiment. As shown in FIG. 2, system 200 includes client 102, network 104, web service 106, LOB system 108, a client-side channel interface 202, and a service-side channel interface 204. As shown in FIG. 2, client-side channel interface 202 is coupled to client 102, and interfaces client 102 with network 104. Furthermore, service-side channel interface 204 is coupled to web service 106, and interfaces web service 106 with network 104.

Client-side channel interface 202 and service-side channel interface 204 are configured to enable communications between client 102 and web service 106, through a channel that includes network 104. Various types of communications between client 102 and web service 106 may be performed, including communication protocols such as SOAP (simple object access protocol) over HTTP (hypertext transfer protocol), SOAP over TCP (transmission control protocol), SOAP over Message Queues, and/or further communication protocols.

For example, in an embodiment, client-side channel interface 202 and service-side channel interface 204 may be configured according to a binding, such as a WCF service layer binding configured to specify how communications occur through a transaction channel established between client 102 and web service 106 (e.g., through network 104). Furthermore, client-side channel interface 202 is configured to propagate client-side state changes regarding a local transaction to the service-side through service-side channel interface 204.

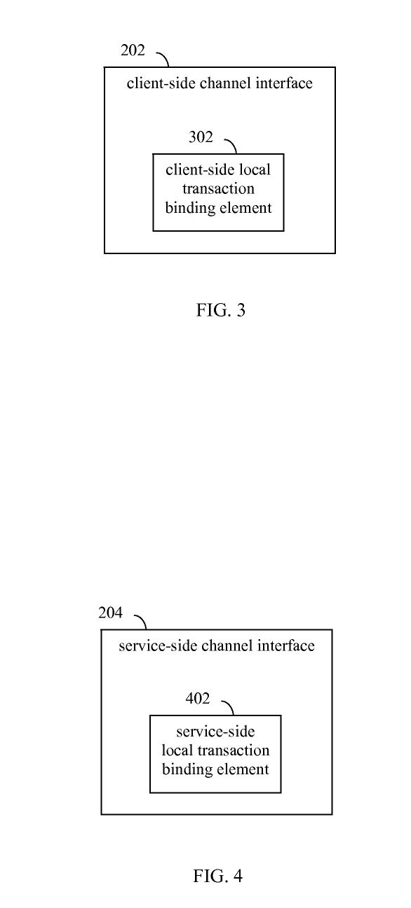

FIG. 3 shows a block diagram of client-side channel interface 202 including a client-side local transaction binding element 302, according to an example embodiment. Furthermore, FIG. 4 shows a block diagram of service-side channel interface 204 including a service-side local transaction binding element 402, according to an example embodiment. Service-side local transaction binding element 402 may expose a contract defining the methods of the operations exposed by web service 106 through service-side channel interface 204. Service-side local transaction binding element 402 may define the binding specifying how client 102 may communicate with web service 106 using client-side local transaction binding element 302. For instance, in an embodiment, client-side channel interface 202 and service-side channel interface 204 may implement a WCF binding stack.

Client 102 and web service 106 communicate with each other to enable LOB system 108 to perform operations of a transaction for client 102 in an atomic fashion. Because the operations of the transaction are to be performed by LOB system 108, the overall transaction may be referred to as a “local transaction.” The local transaction may include any number of one or more operations to be performed by LOB system 108 for client 102. Furthermore, the operations of the local transaction occur atomically, such that they are all performed, or if one or more of them cannot be performed, none of them are performed. Thus, in an embodiment, the local transaction may include an additional operation, referred to as a commit operation, which enables the other operations to all be performed or to all be aborted (e.g., if any one or more of the other operations cannot be performed). The local transaction may be implemented as a program module at client 102, referred to as a “local transaction scope,” such as in the form of C #, C++, Visual Basic, any programming language supported by the Microsoft® .NET Framework, other programming language, or in other form.

For instance, an example of a local transaction may include three operations to be performed at a database maintained by LOB system 108. The three operations may be an “insert” operation, an “update” operation, and a “delete” operation. An example of the local transaction is show below implemented as a C# class:

```
using(LocalTransactionScope ts = new LocalTransactionScope( )
{
  LOBsystem1.Insert( );
  LOBsystem1.Update( );
  LOBsystem1.Delete( );
  ts.Commit( );
}
```

As shown above, the local transaction is implemented as a “LocalTransactionScope,” and includes the three operations (insert operation=LOBsystem1.Insert( ); update operation=LOBsystem1.Update( ); and delete operation=LOBsystem1.Delete( )) to be performed at LOB system 108 (“LOBsystem1”) and a commit operation (ts.Commit( )). The insert, update, and delete operations may be provided by client 102 to LOB system 108 through web service 106, and if all three are successfully performed, the commit operation provides a “commit” instruction to LOB system 108. If any of the three are not successfully performed, the LocalTransactionScope defined by “using” block provides an “abort” instruction to LOB system 108 to abort any successfully completed operation.

Embodiments provide many advantages with regard to enabling client 102 to atomically perform operations at LOB system 108. For instance, client-side channel interface 202, service-side channel interface 204, and a local transaction scope integrated in client 102 provide a generic interface and protocol for interfacing with LOB system 108 through web service 106. As such, system integrators can utilize the generic interface and protocol, and thus do not have to expend additional effort on developing a custom interface and communication protocol. The local transaction scope enables an explicit and implicit model for configuring local transactions at client 102. Client-side channel interface 202 and service-side channel interface 204 implement a transaction protocol between client 102 and web service 106, to bridge client 102 with LOB system 108, and enable access to LOB transactions.

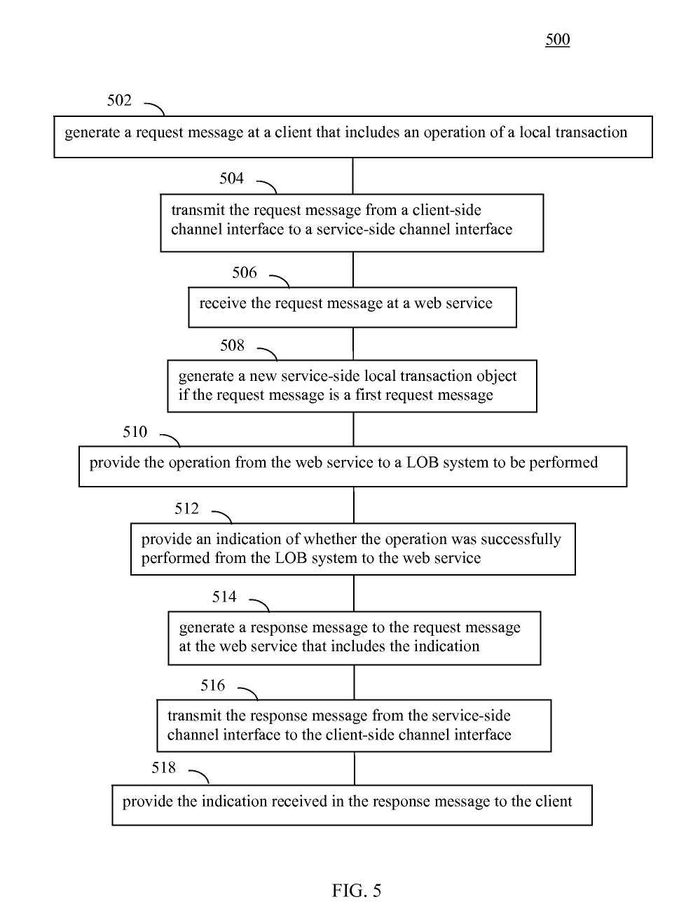

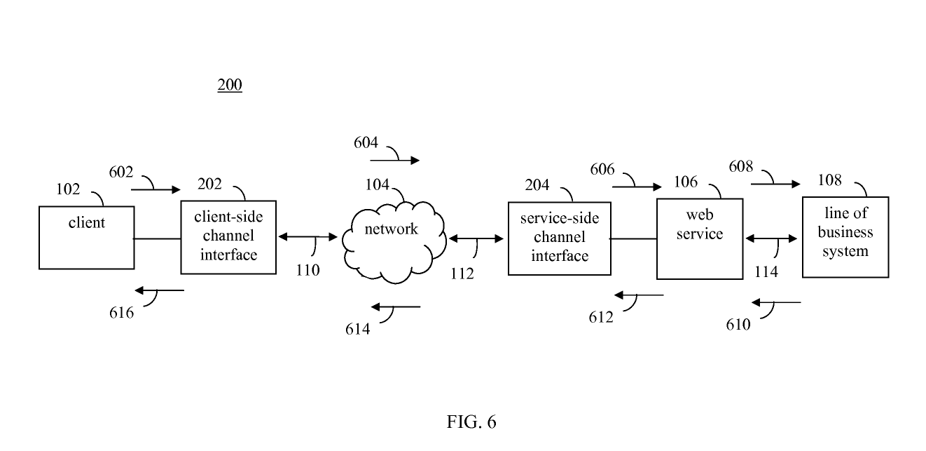

A local transaction may be performed in system 200 in various ways. For example, FIG. 5 shows a flowchart 500 describing a communication protocol for performing a local transaction, according to an embodiment. For instance, system 200 may perform flowchart 500, in an embodiment. Flowchart 500 is described with respect to FIG. 6, which shows system 200 of FIG. 2, and further illustrates communication signals, according to an example embodiment. Other structural and operational embodiments will be apparent to persons skilled in the relevant art(s) based on the discussion regarding flowchart 500. Flowchart 500 is described as follows.

As shown in FIG. 5, flowchart 500 begins with step 502. In step 502, a request message that includes an operation of a local transaction is generated. For example, as shown in FIG. 6, client 102 may generate a request message 602, which includes an operation of a local transaction to be performed by LOB system 108. For instance, in the example local transaction having three operations shown above, the operation may be the “insert” operation. Request message 602 is received by client-side channel interface 202.

In step 504, a request message is transmitted from a client-side channel interface to a service-side channel interface. For instance, as shown in FIG. 6, client-side channel interface 202 may transmit a request message 604 that includes the operation of request message 602, and may include further information, such as a message header that includes transaction identifying information. Examples of such further information are described in further detail further below. As shown in FIG. 6, request message 604 is transmitted through network 104, and is received by service-side channel interface 204.

In step 506, a web service receives the request message. For example, as shown in FIG. 6, service-side channel interface 204 may transmit a request message 606 to web service 106, which includes the operation of request message 604. In an embodiment, service-side channel interface 204 may process further information included in request message 604 received from client-side channel interface 202, such as the message header (e.g., validating the message header, removing the message header), etc.

In step 508, a new service-side local transaction object is generated if the request message is a first request message. For instance, referring to FIG. 6, if request message 606 is a first message received by service-side channel interface 204 that includes an operation of a particular local transaction, service-side channel interface 204 is configured to generate a service-side local transaction object. The service-side local transaction object is configured to track the local transaction at the service-side.

In step 510, the web service provides the operation to a LOB system to be performed. For example, as shown in FIG. 6, web service 106 provides an operation request 608 to LOB system 108. Operation request 608 includes a request to LOB system 108 to perform the operation provided in request message 606.

In step 512, the LOB system provides to the web service an indication of whether the operation was performed successfully. For example, as shown in FIG. 6, LOB system 108 generates an operation response 610, which is received by web service 106. Operation response 610 may include information regarding the results of operation being performed at LOB system 108. Furthermore, or alternatively, operation response 610 may include an indication of whether the operation was performed successfully at LOB system 108.

In step 514, the web service generates a response message to the request message that includes the indication. For example, as shown in FIG. 6, web service 106 generates a response message 612. Response message 612 includes the indication of whether the operation was performed successfully at LOB system 108.

In step 516, the response message is transmitted from the service-side channel interface to the client-side channel interface. For example, as shown in FIG. 6, service-side channel interface 204 receives response message 612 from web service 106. Service-side channel interface 204 generates a response message 614 that includes information included in response message 612 (e.g., including the indication of whether the operation was successfully performed), and may include further information, such as a message header similar to the message header described above. As shown in FIG. 6, response message 614 is transmitted through network 104, and is received by client-side channel interface 202.

In step 518, the indication received in the response message is provided to the client. For example, as shown in FIG. 6, client-side channel interface 204 may transmit a response message 616 to client 102, which includes the indication of whether the operation was performed successfully, which was included in response message 614. In an embodiment, client-side channel interface 202 may process further information included in response message 614 received from service-side channel interface 204, such as the message header (e.g., validating the message header, removing the message header), etc.

As such, flowchart 500 describes an example local transaction protocol that bridges client 102 with LOB system 108, enabling client 102 to perform LOB transactions. Note that flowchart 500 may be repeated for each operation of the local transaction, including the commit operation being processed during a final iteration of flowchart 500. In an embodiment, if each of the indications received by client 102 indicates that the respective operation was successfully performed at LOB system 108, client 102 may generate a completion protocol message transmitted to LOB system 108 that includes a commit instruction. The commit instruction instructs LOB system 108 to commit (e.g., finish performing and/or allow to remain completed) each of the previously transmitted operations of the local transaction. If one or more of the indications received by client 102 indicate that an operation was not successfully performed at LOB system 108, client 102 may generate the completion protocol message to include an abort instruction. The abort instruction instructs LOB system 108 to abort (e.g., cancel and/or undo) each of the previously transmitted operations of the local transaction. Accordingly, LOB system 108 generates a completion type response message that is transmitted to client 102. The completion type response message either indicates that the received abort instruction or commit instruction was performed successfully, or may provide an “in doubt” indication if LOB system 108 is unable to ascertain whether the abort instruction or commit instruction was performed successfully.

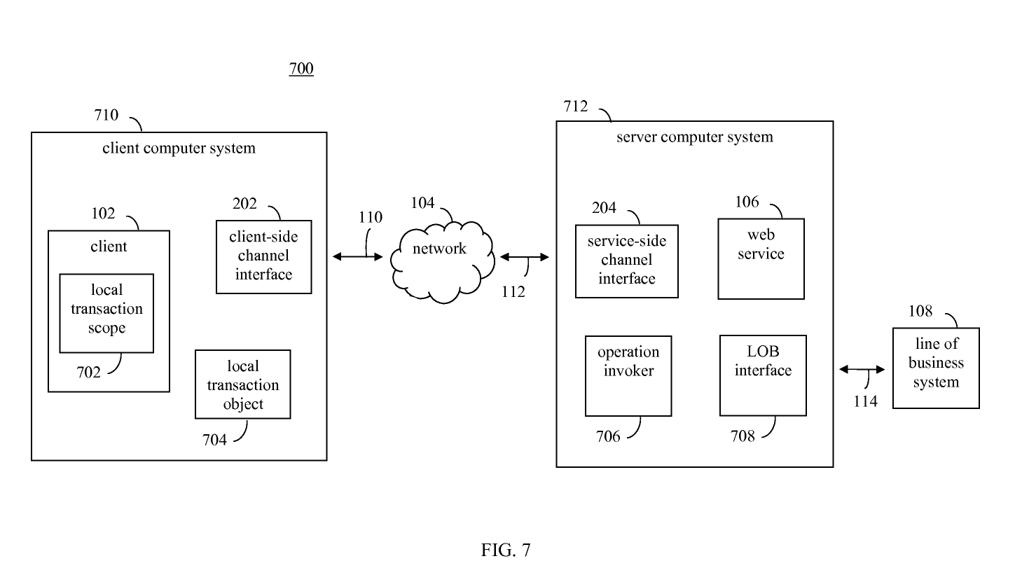

System 200 and flowchart 500 may be implemented in various ways. Example of such embodiments for system 200 and flowchart 500 are described as follows. For instance, FIG. 7 shows a block diagram of a transaction system 700, which is an example of system 200 shown in FIGS. 2 and 6, according to an embodiment. As shown in FIG. 7, system 700 includes a client computer system 710, network 104, a server computer system 712, and LOB system 108. Client computer system 710 includes client 102, client-side channel interface 202, and a client-side local transaction object 704. Furthermore, client 102 includes a local transaction scope 702. Server computer system 712 includes service-side channel interface 204, web service 106, operation invoker 706, and a LOB interface 708. System 700 is described as follows.

Client-side channel interface 202 is configured as a channel interface for client computer system 710, and service-side channel interface 204 is configured as a transaction channel interface for server computer system 712. Local transaction scope 702 includes a plurality of transaction operations and a commit operation for a local transaction to be performed by client 102. Operation invoker 706 is configured to provide transaction operations received over the transaction channel to LOB interface 708. LOB interface 708 is an interface (e.g., an “adaptor”) for communicating with LOB system 108. LOB interface 708 may be a generic interface or may be an interface configured specifically for a particular LOB system 108.

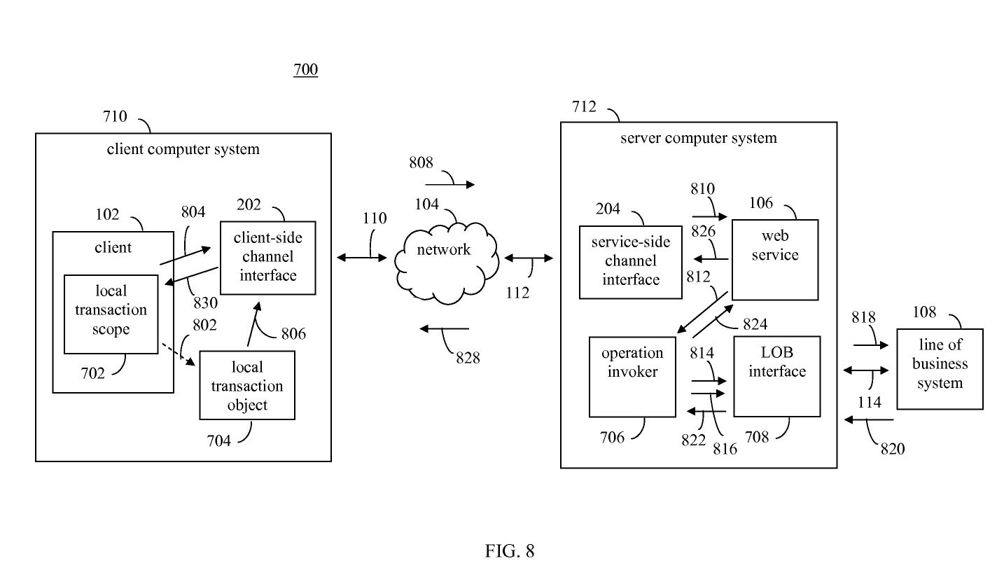

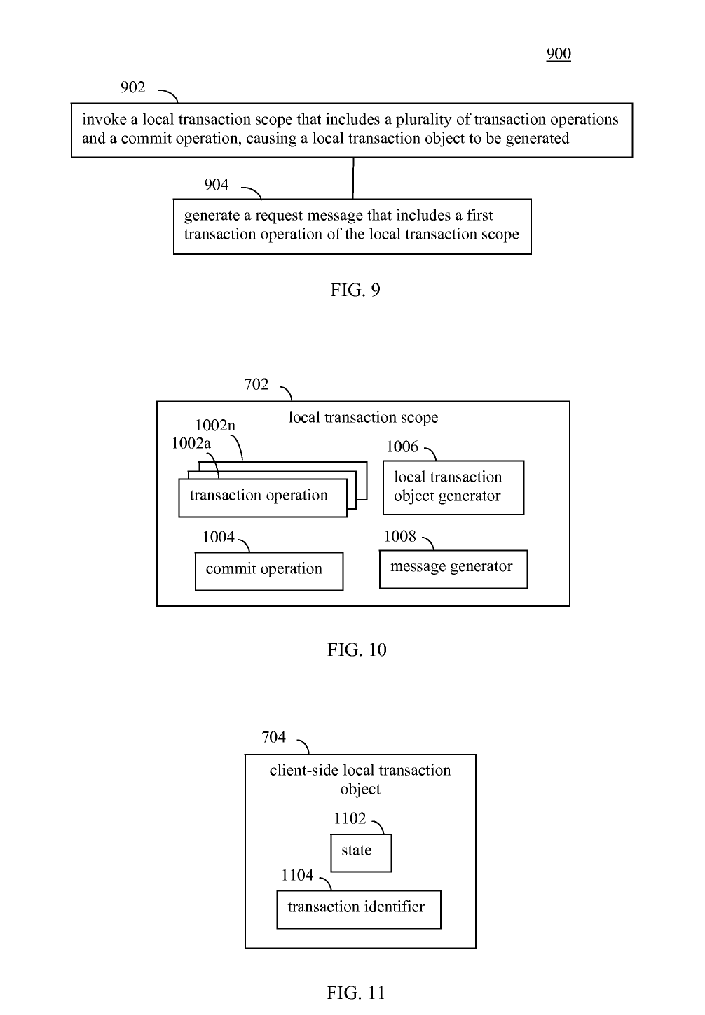

System 700 is further described with respect to FIG. 8, which shows a block diagram of system 700, and further illustrates communications occurring within system 700, according to an example embodiment. System 700 is further described with respect to FIGS. 9-21, which show example flowcharts, which include example embodiments for flowchart 500, and block diagrams of various portions of system 700, according to example embodiments. The next subsection describes example embodiments for performing transaction operations in system 700, followed by a subsection that describes example embodiments for completing a local transaction.

### A. Example Embodiments for Performing Transaction Operations of a Local Transaction in a Local Transaction System

Example embodiments are described in this subsection for performing transaction operations of a local transaction. The example embodiments described herein are provided for illustrative purposes, and are not limiting. Furthermore, additional structural and operational embodiments, including modifications/alterations, will become apparent to persons skilled in the relevant art(s) from the teachings herein.

For example, FIG. 9 shows a flowchart 900 for initiating a local transaction, according to an embodiment. Further structural and operational embodiments will be apparent to persons skilled in the relevant art(s) based on the discussion regarding flowchart 900. Flowchart 900 is described as follows.

As shown in FIG. 9, flowchart 900 begins with step 902. In step 902, a local transaction scope is invoked that includes a plurality of transaction operations and a commit operation, causing a local transaction object to be generated. For example, referring to FIG. 8, client 102 may be configured to invoke local transaction scope 702, which is an example of the local transaction scope described above. Local transaction scope 702 may be invoked in client 102 in any manner according to the configuration of client 102. FIG. 10 shows a block diagram of local transaction scope 702, according to an example embodiment. As shown in FIG. 10, local transaction scope 702 includes a plurality of transaction operations 1002a-1002n and a commit operation 1004. Transaction operations 1002a-1002n are operations to be performed by LOB system 108 for client 102 according to a local transaction defined by local transaction scope 702. Any number of transaction operations 1002 may be present in local transaction scope 702. Commit operation 1004 is an operation that enables the transaction operations 1002a-1002n to all be performed or to all be aborted by LOB system 108. (Note that in some cases, a local transaction scope 702 may include no transaction operations 1002. In such case, no request messages are generated and transmitted to web service 106 to be performed by LOB system 108.)

As shown in FIG. 8, local transaction scope 702 generates client-side local transaction object 704 after being invoked. For instance, as shown in FIG. 10, local transaction scope 702 may include a local transaction object generator 1006. Local transaction object generator 1006 may be configured to generate client-side local transaction object 704. Client-side local transaction object 704 is configured to maintain information regarding the local transaction to be performed, including state information. For example, FIG. 11 shows a block diagram of client-side local transaction object 704. As shown in FIG. 11, client-side local transaction object 704 includes a state 1102 and a transaction identifier 1104. When client-side local transaction object 704 is generated, state 1102 is provided with an initial state, and transaction identifier 1104 may have a null, zero, or empty value.

In step 904, a request message is generated that includes a first transaction operation of the local transaction scope. Referring to FIG. 8, a request message 804 is generated by local transaction scope 702 in client 102. For example, as shown in FIG. 10, local transaction scope 702 may include a message generator 1008 configured to generate request message 804. Message generator 1008 may be configured to generate request message 804 to include a first operation (e.g., first transaction operation 1002a) of local transaction scope 702.

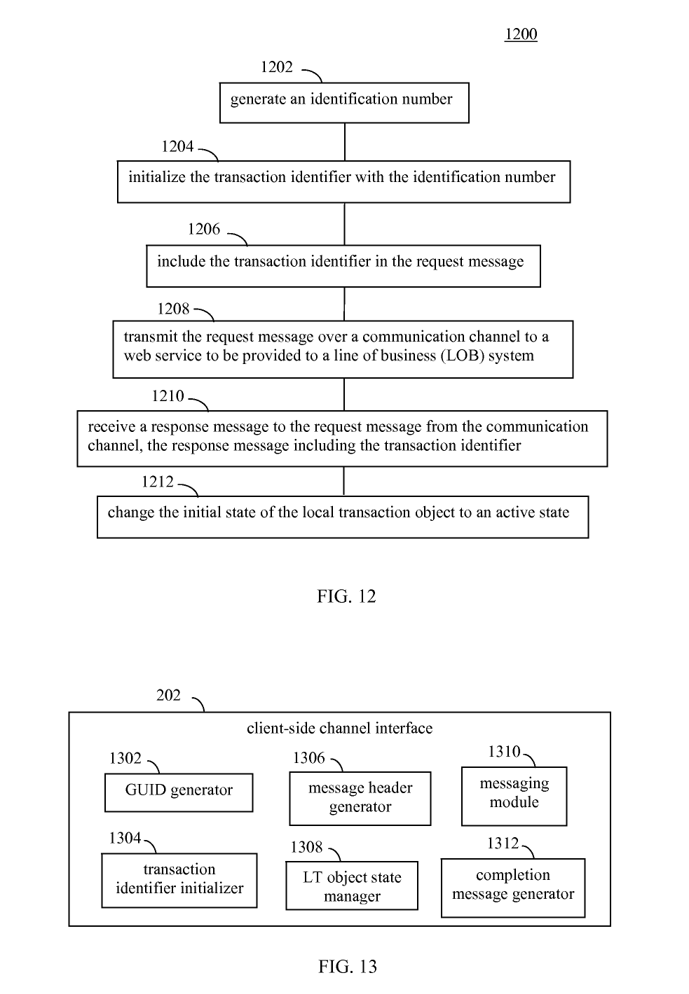

FIG. 12 shows a flowchart 1200 for communicating over the transaction channel at the client-side, according to an example embodiment. For example, flowchart 1200 may be performed by client-side channel interface 202. Note that the steps of flowchart 1200 do not necessarily need to be performed in the order shown in FIG. 12. Further structural and operational embodiments will be apparent to persons skilled in the relevant art(s) based on the discussion regarding flowchart 1200. Flowchart 1200 is described as follows.

As shown in FIG. 12, flowchart 1200 begins with step 1202. In step 1202, an identification number is generated. As shown in FIG. 8, client-side channel interface 202 receives request message 804. In an embodiment, client-side channel interface 202 may be configured to generate an identification number to represent the local transaction being performed upon receiving a first instance of request message 804. For instance, FIG. 13 shows a block-diagram of client-side channel interface 202, according to an example embodiment. As shown in FIG. 13, client-side channel interface 202 may include a GUID (global unique ID) generator 1302. In an embodiment, GUID generator 1302 is configured to generate the identification number as a GUID. The GUID is configured to uniquely identify the current local transaction. For instance, any number of local transactions (having corresponding local transaction objects 704) involving LOB system 108 may occur in an overlapping function, and the GUID is configured to identify communications occurring with a particular local transaction defined by a particular invocation of local transaction scope 702.

In step 1204, the transaction identifier is initialized with the identification number. In an embodiment, client-side channel interface 202 may be configured to initialize transaction identifier 1104 (FIG. 11) of client-side local transaction object 704 with the identification number generated in step 1206. For example, as shown in FIG. 13, client-side channel interface 202 may include a transaction identifier initializer 1304. Transaction identifier initializer 1304 may be configured to initialize transaction identifier 1104 of client-side local transaction object 704 with the identification number generated by GUID generator 1302. As described above, the identification number identifies the particular local transaction associated with client-side local transaction object 704.

In step 1206, the transaction identifier is included in the request message. Referring to FIG. 8, client-side channel interface 202 may be configured to include transaction identifier 1104 (the identification number generated by GUID generator 1302) in request message 804 received from local transaction scope 702.

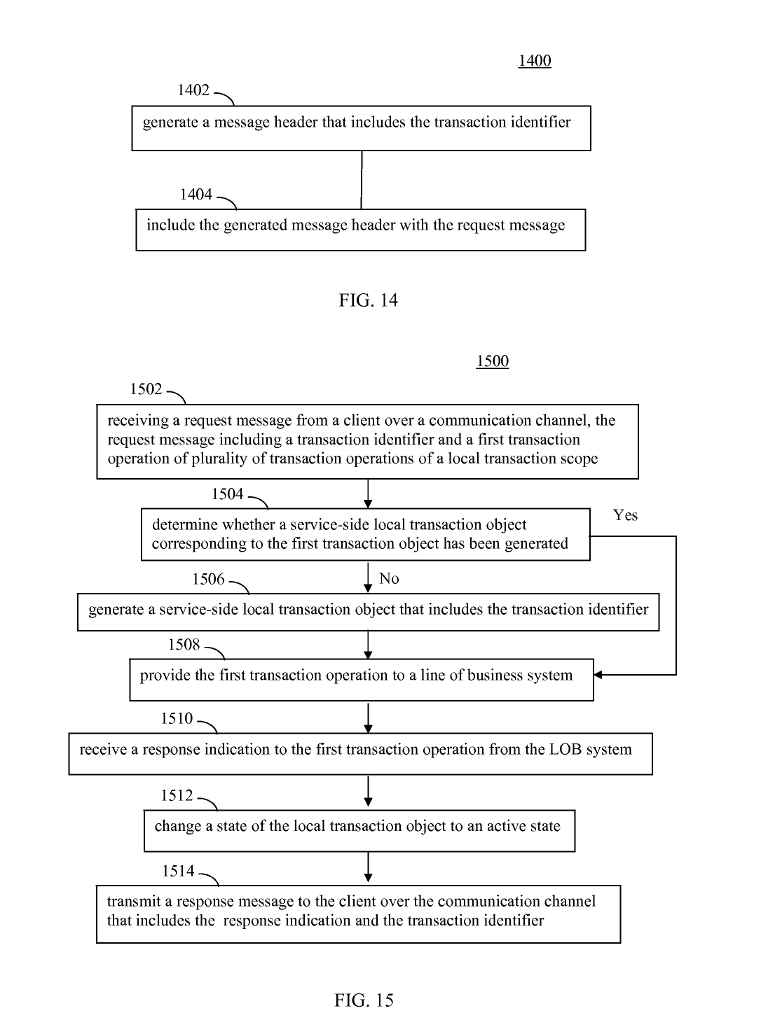

For example, in an embodiment, client-side channel interface 202 may be configured to include transaction identifier 1104 in a portion of request message 804, such as a header portion. For instance, as shown in FIG. 13, in an embodiment, client-side channel interface 202 may include a message header generator 1306. Message header generator 1306 may be configured to generate a message header to be included in request message 804. Message header generator 1306 may be configured to include transaction identifier 1104 in the generated message header. For example, in an embodiment, message header generator 1306 may perform a flowchart 1400 shown in FIG. 14. In step 1402 of flowchart 1400, a message header is generated that includes the transaction identifier. In step 1404, the generated message header is included with the request message.

Message header generator 1306 may generate the message header to have any form. Furthermore, the message header may be generated in any format (e.g., any format that is supported by SOAP (simple object access protocol)), including a programming language such as XML (extensible markup language), JSON (JavaScript object notation), etc. For instance, an example message header is shown as follows in XML programming language form:

<LocalTransactionContext mustUnderstand=“1”
xmlns=“http://schemas.service.com/servicemodel/adapters/
localtransaction”>
<TransactionId>GUID</TransactionId>
</LocalTransactionContext>

Message header generator 1306 may be configured to generate this example message header, inserting the value of transaction identifier 1104 at the location of “GUID”, and setting “xmlns” to a constant value (e.g., a URI value in the current example). In an embodiment, each message header that is transmitted to the service-side has an xmlns value assigned, or the service-side will refuse to treat the message as valid local transaction message. This is analogous to the situation where a first person visits an office and asks a receptionist to see a second person, who is an employee at the office. The receptionist will typically perform appropriate actions to direct you to the second person. If there the second person is not an employee, the receptionist may let the first person know, and the first person returns empty handed. Similarly, the request message header includes a value for xmlns that is expected by web service 106. If the xmlns value does not match an expected value, the request message that includes the message header will not be processed by the service-side. “xmlns” is referred to as namespace. Each entity in an XML document is defined under a particular namespace. For more details regarding namespaces, refer to “Namespaces in XML 1.0 (Second Edition), W3C Recommendation 16 Aug. 2006”, XML Core Working Group, Aug. 16, 2006, which may be accessible at http://www.w3.org/TR/REC-xml-names/, and which is incorporated by reference herein in its entity.

In an embodiment, as shown in FIG. 13, client-side channel interface 202 may include a messaging module 1310 configured to generate a request message 808. Messaging module 1310 may be configured to generate request message 808 to include the transaction operation received in request message 804 and transaction identifier 1104. For example, messaging module 1310 may include the message header generated by message header generator 1306 in request message 808. Furthermore, messaging module 1310 may be configured to “serialize” request message 808 into a “wire-format” suitable for transmission.

In step 1208, the request message is transmitted over a communication channel to a web service to be provided to a line of business (LOB) system. Referring to FIG. 8, client-side channel interface 202 may be configured to transmit request message 808 to service-side channel interface 204 through network 104. In an embodiment, client computer system 710 may include a network interface (e.g., as described further below) configured to enable communications over network 104.

Server computer system 712 receives and processes request message 808. For instance, FIG. 15 shows a flowchart 1500 for communicating over the transaction channel at the service-side, according to an example embodiment. For example, flowchart 1500 may be performed by service-side channel interface 204. Further structural and operational embodiments will be apparent to persons skilled in the relevant art(s) based on the discussion regarding flowchart 1500. Flowchart 1500 is described as follows.

As shown in FIG. 15, flowchart 1500 begins with step 1502. In step 1502, a request message is received from a client over a communication channel, the request message including a transaction identifier and a first transaction operation of plurality of transaction operations of a local transaction scope. For example, as shown in FIG. 8, service-side channel interface 204 receives request message 808 from client-side channel interface 202 over network 104. As described above, request message 808 includes transaction identifier 1104 and a first transaction operation (e.g., transaction operation 1002a) of the transaction operations of local transaction scope 702. In an embodiment, server computer system 712 may include a network interface (e.g., as described further below) configured to enable communications over network 104.

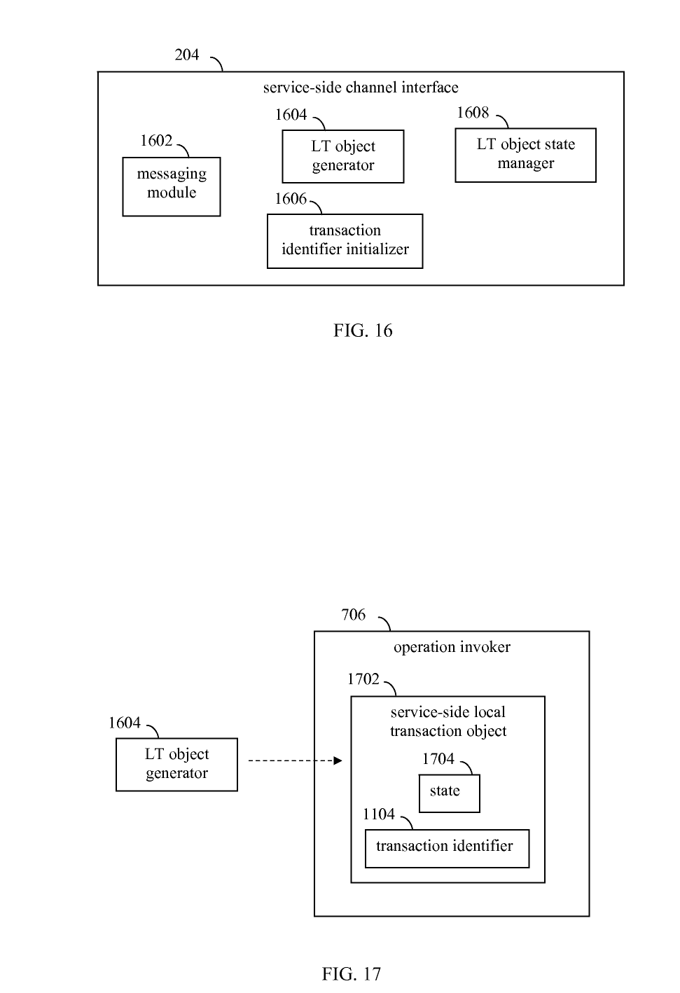

FIG. 16 shows a block diagram of service-side channel interface 204, according to an example embodiment. As shown in FIG. 16, service-side channel interface 204 may include a messaging module 1602 configured to receive (e.g., de-serialize) and parse request message 808. For example, messaging module 1602 may extract transaction identifier 1104, the contract identifier in the message header described above, and the transaction operation included in request message 808 (e.g., in a message body). Service-side channel interface 204 may use transaction identifier 1104 to associate request message 808 with a particular local transaction being performed.

In step 1504, whether a service-side local transaction object corresponding to the first transaction object has been generated is determined. For example, in an embodiment, when request message 808 is a first received request message of a local transaction, service-side channel interface 202 may be configured to determine whether a service-side local transaction object corresponding to the local transaction has been generated. As described below, the service-side local transaction object is generated to enable tracking of the local transaction on the service-side. If a service-side local transaction object corresponding to the local transaction is determined to not have been generated, operation proceeds to step 1506. If a service-side local transaction object corresponding to the local transaction is determined to already have been generated, operation proceeds to step 1508.

In step 1506, a service-side local transaction object is generated that includes the transaction identifier. For example, in an embodiment, when request message 808 is a first received request message of a local transaction, service-side channel interface 202 may be configured to generate a service-side local transaction object that includes transaction identifier 1104 from request message 808. The generated service-side local transaction object is configured to track on the service-side a state of the local transaction associated with transaction identifier 1104.

For example, as shown in FIG. 16, service-side channel interface 204 may include a local transaction (LT) object generator 1604. LT object generator 1604 is configured to generate a service-side local transaction object that includes transaction identifier 1104 and a state of the local transaction. For example, FIG. 17 shows a block diagram of LT object generator 1604 generating a service-side local transaction object 1702. As shown in FIG. 17, service-side local transaction object 1702 may include a state 1704 and transaction identifier 1104. When generated, state 1704 is provided with an initial state. For example, as shown in FIG. 16, service-side channel interface 204 may include an LT object state manager 1608 configured to manage state 1704, including providing state 1704 with the initial state. Transaction identifier 1104 is used to identify the particular local transaction with which service-side local transaction object 1702 is associated. Service-side local transaction object 1702 may be provided at any suitable location, such as being included in operation invoker 706, as shown in FIG. 17.

In step 1508, the first transaction operation is provided to a line of business system. For example, as shown in FIG. 8, service-side channel interface 204 is configured to transmit a message 810 to web service 106, which includes the transaction operation and further local transaction information that was included in request message 808. Web service 106 transmits a message 812 to operation invoker 706 which includes the transaction operation and further local transaction information that was included in request message 808. Operation invoker 706 provides the transaction operation to LOB interface 708 as transaction operation 814. Furthermore, if the transaction operation is the first transaction operation to be received that is associated with service-side local transaction object 1702, operation invoker 706 provides an indication 816 to LOB interface 708 that an instance of the local transaction is being initiated. LOB interface 708 is configured to transmit the transaction operation to LOB system 108 as transaction operation 818 (e.g., over communication link 114). LOB system 108 performs the operation indicated by transaction operation 818.

In step 1510, a response indication to the first transaction operation is received from the LOB system. For example, as shown in FIG. 8, LOB system 108 generates a response indication 820 that indicates whether the transaction operation was successfully completed or failed. Response indication 820 is transmitted to LOB interface 708. LOB interface 708 provides response indication 820 to operation invoker 706 as response indication 822. Operation invoker 706 provides response indication 822 to web service 106 as response indication 824. Web service 106 provides response indication 824 to service-side channel interface 204 as response indication 826.

In step 1512, a state of the local transaction object is changed to an active state. For example, in an embodiment, LT object state manager 1608 (FIG. 16) is configured to change state 1704 of service-side local transaction object 1702 (FIG. 17) to an active state from the initial state upon receiving a first response indication from LOB system 108 regarding a first transaction operation of the local transaction.

In step 1514, the response message that includes the response indication and the transaction identifier is transmitted to the client over the communication channel. In an embodiment, as shown in FIG. 16, messaging module 1602 may be configured to generate a response message 828 that includes response indication 826 and transaction identifier 1104. For example, in an embodiment, messaging module 1602 may include a message header similar to a message header received in request message 808. Although not shown in FIG. 16, service-side channel interface 204 may include a message generator configured to generate a message header that includes transaction identifier 1104. The message header for response message 828 may have any form and format, similar to the message header included in request message 808. Messaging module 1602 may include response indication 826 is a message body or other portion of response message 828. Referring to FIG. 8, service-side channel identifier 204 may be configured to serialize and transmit response message 828 to client-side channel interface 202 through network 104.

Referring back to flowchart 1200 shown in FIG. 12, in step 1210, a response message to the request message is received from the communication channel, the response message including the transaction identifier. For example, as shown in FIG. 8, client-side channel interface 202 receives response message 828 from service-side channel interface 204. As described above, response message 828 includes transaction identifier 1104, which identifies the local transaction associated with response message 828. In an embodiment, as shown in FIG. 13, messaging module 1310 may be configured to receive (e.g., de-serialize) and parse response message 828. As shown in FIG. 8, client-side channel interface 202 may transmit response information 830 to local transaction scope 702 of client 102 indicating whether response message 828 indicates whether the transaction operation was successful or failed at LOB system 108.

In step 1212, the initial state of the local transaction object is changed to an active state. For example, in an embodiment, LT object state manager 1308 may be configured to change state 1102 of client-side local transaction object 704 from the initial state to an active state upon receiving a first response message from service-side channel interface 204 regarding the local transaction associated with client-side local transaction object 704 (e.g., identified by transaction identifier 1104).

As described above, local transaction scope 702 may include one or more additional transaction operations 1002b-1002n in addition to the first transaction operation 1002a. Portions of flowcharts 900, 1200, and 1500 may be performed for each additional transaction operation. For example, in step 904 (flowchart 900 in FIG. 9), a next request message may be generated that includes a next transaction operation of the local transaction scope (and includes transaction identifier 1104), and steps 1206 and 1208 of flowchart 1200 (FIG. 12), steps 1502, 1508, 1510, and 1514 of flowchart 1500 (FIG. 15), and step 1210 of flowchart 1200 may be repeated for the next transaction operation. These steps may be repeated for each additional transaction operation until all of the transaction operations of local transaction scope 702 are performed, and/or until a failure for a transaction operation is indicated by LOB system 108 in response indication 820 for a transaction operation.

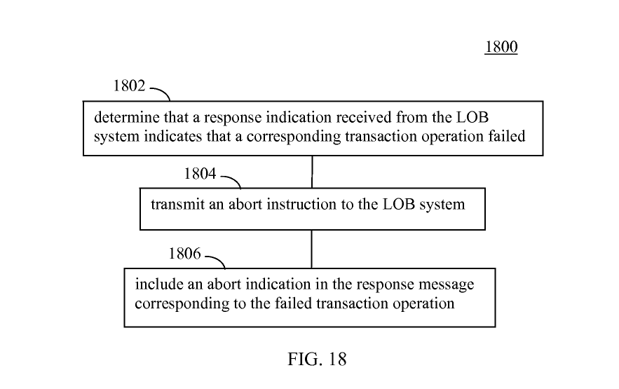

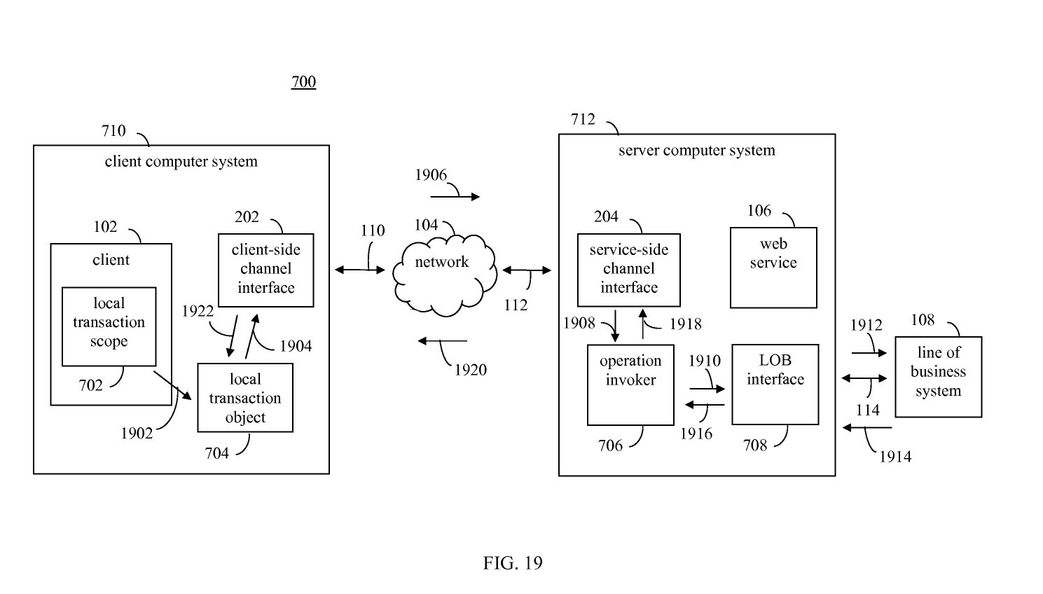

For example, FIG. 18 shows a flowchart 1800 for handling a transaction operation failure at the service-side, according to an example embodiment. Further structural and operational embodiments will be apparent to persons skilled in the relevant art(s) based on the discussion regarding flowchart 1800. Flowchart 1800 is described as follows.

As shown in FIG. 18, flowchart 1800 begins with step 1802. In step 1802, a response indication received from the LOB system is determined to indicate that a corresponding transaction operation failed. For example, referring to FIG. 8, response indication 820 received by LOB interface 708 may indicate a failure of the corresponding transaction operation (e.g., one of transaction operations 1002a-1002n of FIG. 10) provided to LOB system 108. Alternatively, LOB system 108 may not respond to a transaction operation with a response indication 820 (e.g., an allotted response time may expire (timeout)) to LOB interface 708, and thus LOB interface 708 may interpret the lack of response as a failure of the corresponding transaction operation at LOB system 108. LOB interface 708 may transmit a failure indication in response indication 822 to operation invoker 706.

In step 1804, an abort instruction is transmitted to the LOB system. In an embodiment, in response to the failure indication received from LOB interface 708, operation invoker 706 may transmit an abort instruction to LOB interface 708 to abort the present local transaction because if one transaction operation fails, the local transaction cannot be performed atomically, and thus all transaction operations of the local transaction are to be aborted. As a result, LOB interface 708 may terminate the current instance of the local transaction, and may transmit one or more instructions to LOB system 108 to abort transaction operations associated with the local transaction.

In step 1806, an abort indication is included in the response message corresponding to the failed transaction operation. For example, referring to FIG. 8, operation invoker 706 may include an abort indication in response indication 824, which is transmitted to client-side channel interface 202 in response message 828, to indicate that the local transaction is being aborted.

### B. Example Embodiments for Completing a Local Transaction in a Local Transaction System

Example embodiments are described in this subsection for completing a local transaction. For purposes of illustration, embodiments in this section are described with respect to FIG. 19, which shows a block diagram of system 700 of FIG. 7, and further showing example communications in system 700, according to an example embodiment. The example embodiments described herein are provided for illustrative purposes, and are not limiting. Furthermore, additional structural and operational embodiments, including modifications/alterations, will become apparent to persons skilled in the relevant art(s) from the teachings herein.

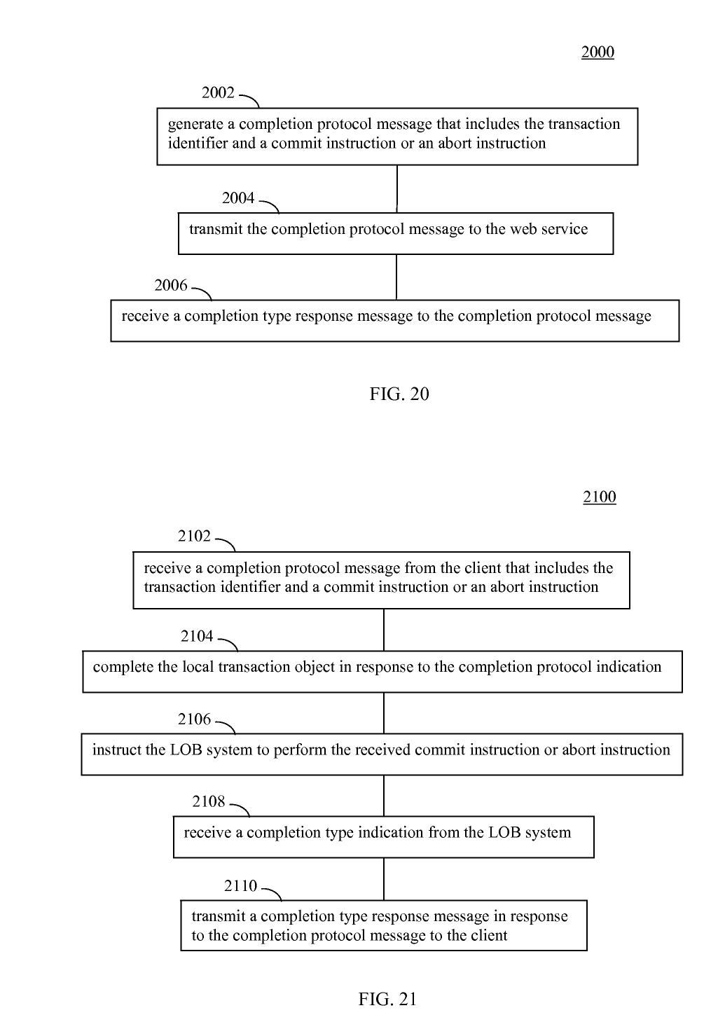

For example, FIG. 20 shows a flowchart 2000 for completing a local transaction at the client-side, according to an embodiment. For example, flowchart 2000 may be performed subsequently to providing all of the transaction operations of local transaction scope 702 to LOB system 108, as described in the preceding subsection. Further structural and operational embodiments will be apparent to persons skilled in the relevant art(s) based on the discussion regarding flowchart 2000. Flowchart 2000 is described as follows.

As shown in FIG. 20, flowchart 2000 begins with step 2002. In step 2002, a completion protocol message is generated that includes the transaction identifier and a commit instruction or an abort instruction. For example, referring to FIG. 19, local transaction scope 702 at client 102 may be configured to track response information 830 regarding transaction operations performed by LOB system 108. For example, commit operation 1004 may be configured to determine whether a response is received for each transaction operation provided to LOB system 108, and to track the success or failure of each transaction operation indicted in response information 830. If a failure of a transaction operation is indicated (e.g., an abort indication is received in one or more of response information 830 received for one or more transaction operations), commit operation 1004 indicates a failure (e.g., “abort”) in a completion indication 1902. In such case, the local transaction is to be aborted. If all transaction operations are verified as successful, commit operation 1004 indicates a success (e.g., “commit”) in completion indication 1902.

As shown in FIG. 19, completion indication 1902 is received by client-side local transaction object 704. Client-side local transaction object 704 provides completion indication 1902 to client-side channel interface 202 as completion indication 1904. For example, client-side local transaction object 704 may provide completion indication 1902 in the form of a “TransactionCompleteRequest” event handler, or other form. Client-side channel interface 202 is configured to generate a completion protocol message 1906 that includes a commit instruction or an abort instruction. For example, as shown in FIG. 13, client-side channel interface 202 may include a completion message generator 1312. Completion message generator 1312 is configured to generate completion protocol message 1906.

Completion message generator 1312 may generate completion protocol message 1906 to have any form. Furthermore, completion protocol message 1906 may be generated in any format, including a programming language such as XML (extensible markup language), JSON (JavaScript object notation), etc. For instance, an example of completion protocol message 1906 is shown as follows in XML programming language form:

```
<LocalTransactionContext mustUnderstand=“1”
xmlns=“http://schemas.service.com/servicemodel/adapters/
localtransaction”>
  <TransactionId>GUID</TransactionId>
  <Command>[Commit/Abort]</Command>
</LocalTransactionContext>
<Action mustUnderstand = “1”> http://schemas.service.com/servicemodel/
adapters/localtransaction/CompletionAction</Action>
<Body/>
```

Completion message generator 1312 may be configured to generate this example of completion protocol message 1906, inserting the value of transaction identifier 1104 at the location of “GUID”, and setting “xmlns” to a constant value, as described above. Furthermore, either “Commit” (a commit instruction) or “Abort” (an abort instruction) may be selected at the location of “Commit/Abort”, depending on whether completion indication 1902 indicates a success (for all transaction operations) or a failure (for at least one transaction operation).

In step 2004, the completion protocol message is transmitted to the web service. Referring to FIG. 19, client-side channel interface 202 may be configured to transmit completion protocol message 1906 to service-side channel interface 204 through network 104.

FIG. 21 shows a flowchart 2100 for completing a local transaction at the service-side, according to an embodiment. Further structural and operational embodiments will be apparent to persons skilled in the relevant art(s) based on the discussion regarding flowchart 2100. Flowchart 2100 is described as follows.

As shown in FIG. 21, flowchart 2100 begins with step 2102. In step 2102, a completion protocol message is received from the client that includes the transaction identifier and a commit instruction or an abort instruction. For example, as shown in FIG. 19, service-side channel interface 204 receives completion protocol message 1906 from client-side channel interface 202 over network 104. As described above, completion protocol message 1906 includes transaction identifier 1104 and a commit instruction or an abort instruction.

In step 2104, the local transaction object is completed in response to the completion protocol indication. For example, in an embodiment, service side channel interface 204 (e.g., LT object state manager 1608) may be configured to complete service-side local transaction object 1702 after receiving completion protocol message 1906.

In step 2106, the LOB system is instructed to perform the received commit instruction or abort instruction. For example, as shown in FIG. 19, service-side channel interface 204 provides a completion instruction 1908 to operation invoker 706. Operation invoker 706 provides completion instruction 1908 to LOB interface 708 as completion instruction 1910. LOB interface 708 is configured to provide completion instruction 1910 to LOB system 12 as completion instruction 1912. If completion instruction 1910 is a commit instruction, LOB system 108 enables each of the transaction operations to be completed. If completion instruction 1910 is an abort instruction, LOB system 108 attempts to abort all of the transaction operations (if LOB system 108 has not already done this according to flowchart 1800 described above).

In step 2108, a completion type indication is received from the LOB system. In an embodiment, LOB system 108 generates a completion type indication 1914 that indicates whether completion instruction 1912 was performed successfully. For example, if completion instruction 1910 was a commit instruction that was performed successfully, completion type indication 1914 may indicate “commit” or other indication of success of the commit instruction. If completion instruction 1910 was an abort instruction that was performed successfully, completion type indication 1914 may indicate “abort” or other indication of success of the abort instruction. If LOB system 108 is unable to determine whether the commit instruction or abort instruction of completion instruction 1910 was performed successfully, completion type indication 1914 may indicate “in doubt” or other indication that success of instruction was not verified.

In step 2110, the completion type response message is transmitted to the client in response to the completion protocol message. For example, as shown in FIG. 19, LOB interface 708 receives completion type indication 1914. LOB interface 708 provides completion type indication 1914 to operation invoker 706 as completion type indication 1916. Operation invoker 706 may provide completion type indication 1916 to service-side channel interface 204 as completion type indication 1918.

In an embodiment, messaging module 1602 (FIG. 16) may be configured to generate a completion type response message 1920 that includes completion type indication 1918 and transaction identifier 1104. For example, in an embodiment, messaging module 1602 may generate completion type response message 1920 to be similar in form to completion protocol message 1906. For example, in an embodiment, completion type response message may appear as shown below:

```
<LocalTransactionContext mustUnderstand=“1”
xmlns=“http://schemas.microsoft.com/servicemodel/adapters/
localtransaction”>
  <TransactionId>ID1</TransactionId>
  <Command>[Commit/Abort/InDoubt]</Command>
</LocalTransactionContext>
<Action mustUnderstand=“1”>http://schemas.microsoft.com/servicemodel/
adapters/localtransaction/CompletionAction/response</Action>
<Body/>
```

Messaging module 1602 may be configured to generate this example of completion type response message 1920, inserting the value of transaction identifier 1104 at the location of “GUID”, and setting xmlns to a constant value, as described above. Furthermore, either “Commit” (an indication of a successful commit), “Abort” (an indication of a successful abort), or “InDoubt” (an indication that a successful commit or abort was not verified) may be selected at the location of “Commit/Abort/InDoubt”, depending on completion type indication 1918.

Referring to FIG. 19, service-side channel identifier 204 may be configured to serialize and transmit completion type response message 1920 to client-side channel interface 202 through network 104.

Referring back to flowchart 2000 in FIG. 20, in step 2006, a completion type response message to the completion protocol message is received. For example, as shown in FIG. 19, client-side channel interface 202 receives completion type response message 1920 from service-side channel interface 204. As described above, completion type response message 1920 includes transaction identifier 1104 and provides an indication regarding the success of the corresponding completion protocol message 1906. In an embodiment, messaging module 1310 (FIG. 13) may be configured to receive (e.g., de-serialize) and parse completion type response message 1920. As shown in FIG. 19, client-side channel interface 202 may transmit completion type information 1922 to client-side local transaction object 704 (and/or to client 102) indicating whether completion type response message 1920 indicates whether the completion of the local transaction was committed, aborted, or in doubt.

### IV. Example Embodiments for Handling a Local Transaction Scope that References Multiple Line of Business Systems

In an embodiment, systems 100 (FIG. 1), 200 (FIG. 2), and 700 (FIG. 7) may be configured to process multiple LOB systems referenced by operations in a single local transaction scope, as a form of distributed transaction. In another embodiment, if multiple LOB systems are referenced by operations in a single local transaction scope, a failure of the local transaction scope occurs.

For example, a local transaction scope is shown as follows that references multiple LOB systems (implemented as a C# class):

```
using(LocalTransactionScope ts = new LocalTransactionScope( )
{
  LOBsystem1.Insert( );
  LOBsystem1.Update( );
  LOBsystem1.Delete( );
  LOBsystem2.Insert( );
  LOBsystem2.Update( );
  LOBsystem2.Delete( );
  ts.Commit( );
}
```

As shown above, the local transaction scope references two LOB systems, a “LOBsystem1” and a “LOBsystem2.” Three operations (insert, update, and delete) are designated in the local transaction scope to be performed by each of LOBsystem1 and LOBsystem2, for a total of six operations. Furthermore, a commit operation (ts.Commit( )) is present to be executed if the six operations are successfully performed. The insert, update, and delete operations may be provided by client 102 to a pair of LOB systems 108 through web service 106.

As described above, in one embodiment, this local transaction scope, which references multiple LOB systems, may result in a failure if invoked. For example, when the operation LOBsystem2.Insert( ) is executed, this operation would throw an exception, and the local transaction scope would be aborted. Such a scenario will not be allowed because transactions dealing with multiple LOB systems may be better handled in a distributed transaction that is coordinated by a distributed transaction manager.

For instance, in an embodiment, if this local transaction scope is executed, steps 902 and 904 of flowchart 900 (FIG. 9) may be performed, such that a local transaction object is generated, and a first request message is generated that includes the LOBsystem1.Insert( ) operation. With reference to flowchart 1200 (FIG. 12), an identification number is generated (step 1202) and transaction identifier 1104 is initialized with the identification number (step 1204). Transaction identifier 1104 is included in the request message (step 1206), and the request message is transmitted to web service 106 (step 1208). According to flowchart 1500 (FIG. 15), the request message is received (step 1502), service-side local transaction object 1702 is generated (steps 1504 and 1506), and steps 1508-1514 may be performed such that LOB system 108 performs the operation and a response message transmitted back to client 102. Referring back to flowchart 1200, the response message is received (step 1210), and the state 1102 of client-side local transaction object 704 transitions from an initial state to an active state. The LOBsystem1.Update( ) and LOBsystem1.Delete( ) operations may also be transmitted in request messages to web service 106 in a similar fashion. Each request message includes transaction identifier 1104. Because transaction identifier 1104 is recognized on the service-side, these two operations can be performed.

However, with regard to the LOBsystem2.Insert( ), this operation is included in a request message (in step 904), which is a first message directed to LOBsystem2 over a second transaction channel. Because this operation is directed to a second LOB system, client-side channel interface 202 may attempt to re-perform step 1204 to re-initial transaction identifier 1104 for client-side local transaction object 704. Because transaction identifier 1104 is already initialized, however, this second re-initialize attempt would fail, causing the local transaction scope to be aborted.

### IV. Further Example Embodiments

Client-side channel interface 202, service-side channel interface 204, client-side local transaction binding element 302, service-side local transaction binding element 402, local transaction scope 702, client-side local transaction object 704, operation invoker 706, LOB interface 708, local transaction object generator 1006, message generator 1008, GUID generator 1302, transaction identifier initialize 1304, message header generator 1306, LT object state manager 1308, messaging module 1310, completion message generator 1312, messaging module 1602, LT object generator 1604, transaction identifier initialize 1606, LT object state manager 1608, and service-side local transaction object 1702 may be implemented in hardware, software, firmware, or any combination thereof.

For example, client-side channel interface 202, service-side channel interface 204, client-side local transaction binding element 302, service-side local transaction binding element 402, local transaction scope 702, client-side local transaction object 704, operation invoker 706, LOB interface 708, local transaction object generator 1006, message generator 1008, GUID generator 1302, transaction identifier initialize 1304, message header generator 1306, LT object state manager 1308, messaging module 1310, completion message generator 1312, messaging module 1602, LT object generator 1604, transaction identifier initialize 1606, LT object state manager 1608, and/or service-side local transaction object 1702 may be implemented as computer program code configured to be executed in one or more processors. Alternatively, client-side channel interface 202, service-side channel interface 204, client-side local transaction binding element 302, service-side local transaction binding element 402, local transaction scope 702, client-side local transaction object 704, operation invoker 706, LOB interface 708, local transaction object generator 1006, message generator 1008, GUID generator 1302, transaction identifier initialize 1304, message header generator 1306, LT object state manager 1308, messaging module 1310, completion message generator 1312, messaging module 1602, LT object generator 1604, transaction identifier initialize 1606, LT object state manager 1608, and/or service-side local transaction object 1702 may be implemented as hardware logic/electrical circuitry.

For instance, in an embodiment, GUID generator 1302, transaction identifier initialize 1304, message header generator 1306, LT object state manager 1308, messaging module 1310, and completion message generator 1312 may be implemented in client-side local transaction binding element 302. Furthermore, in an embodiment, messaging module 1602, LT object generator 1604, transaction identifier initialize 1606, and LT object state manager 1608 may be implemented in service-side local transaction binding element 402.

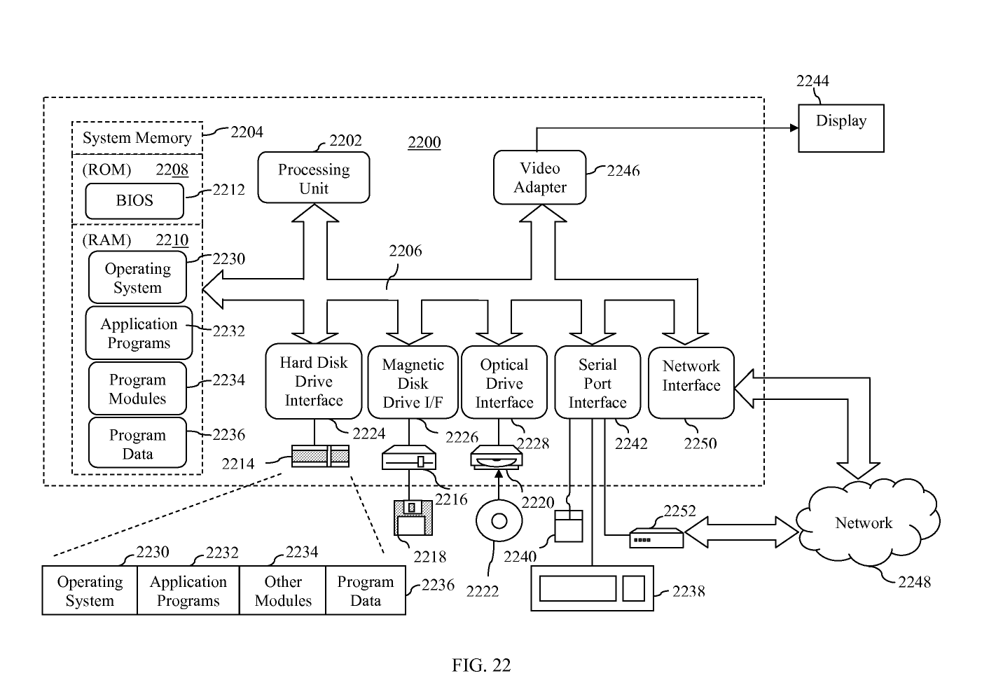

FIG. 22 depicts an exemplary implementation of a computer 2200 in which embodiments of the present invention may be implemented. For instance, client computer system 710 and/or server computer system 712 may be implemented similarly to computer 2200, and may include one or more features of computer 2200 and/or alternative features. Computer 2200 may be a general-purpose computing device in the form of a conventional personal computer, a mobile computer, or a workstation, for example, or computer 2200 may be a special purpose computing device. The description of computer 2200 provided herein is provided for purposes of illustration, and is not intended to be limiting. Embodiments of the present invention may be implemented in further types of computer systems, as would be known to persons skilled in the relevant art(s).

As shown in FIG. 22, computer 2200 includes a processing unit 2202, a system memory 2204, and a bus 2206 that couples various system components including system memory 2204 to processing unit 2202. Bus 2206 represents one or more of any of several types of bus structures, including a memory bus or memory controller, a peripheral bus, an accelerated graphics port, and a processor or local bus using any of a variety of bus architectures. System memory 2204 includes read only memory (ROM) 2208 and random access memory (RAM) 2210. A basic input/output system 2212 (BIOS) is stored in ROM 2208.

Computer 2200 also has one or more of the following drives: a hard disk drive 2214 for reading from and writing to a hard disk, a magnetic disk drive 2216 for reading from or writing to a removable magnetic disk 2218, and an optical disk drive 2220 for reading from or writing to a removable optical disk 2222 such as a CD ROM, DVD ROM, or other optical media. Hard disk drive 2214, magnetic disk drive 2216, and optical disk drive 2220 are connected to bus 2206 by a hard disk drive interface 2224, a magnetic disk drive interface 2226, and an optical drive interface 2228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 2230, one or more application programs 2232, other program modules 2234, and program data 2236. Application programs 2232 or program modules 2234 may include, for example, computer program logic for implementing client-side channel interface 202, service-side channel interface 204, client-side local transaction binding element 302, service-side local transaction binding element 402, local transaction scope 702, client-side local transaction object 704, operation invoker 706, LOB interface 708, local transaction object generator 1006, message generator 1008, GUID generator 1302, transaction identifier initialize 1304, message header generator 1306, LT object state manager 1308, messaging module 1310, completion message generator 1312, messaging module 1602, LT object generator 1604, transaction identifier initialize 1606, LT object state manager 1608, service-side local transaction object 1702, flowchart 500, flowchart 900, flowchart 1200, flowchart 1400, flowchart 1500, flowchart 1800, flowchart 2000, and/or flowchart 2100 (including any step of flowcharts 500, 900, 1200, 1400, 1500, 1800, 2000, and/or 2100), and/or any further embodiments as described above.

A user may enter commands and information into the computer 2200 through input devices such as keyboard 2238 and pointing device 2240. Other input devices (not shown) may include a microphone, joystick, game pad, satellite dish, scanner, or the like. These and other input devices are often connected to the processing unit 2202 through a serial port interface 2242 that is coupled to bus 2206, but may be connected by other interfaces, such as a parallel port, game port, or a universal serial bus (USB).

A monitor 2244 or other type of display device is also connected to bus 2206 via an interface, such as a video adapter 2246. In addition to the monitor, computer 2200 may include other peripheral output devices (not shown) such as speakers and printers.

Computer 2200 is connected to a network 2248 (e.g., the Internet) through a network adaptor or interface 2250, a modem 2252, or other means for establishing communications over the network. Modem 2252, which may be internal or external, is connected to bus 2206 via serial port interface 2242.

As used herein, the terms “computer program medium” and “computer-readable medium” are used to generally refer to media such as the hard disk associated with hard disk drive 2214, removable magnetic disk 2218, removable optical disk 2222, as well as other media such as flash memory cards, digital video disks, random access memories (RAMs), read only memories (ROM), and the like.

As noted above, computer programs and modules (including application programs 2232 and other program modules 2234) may be stored on the hard disk, magnetic disk, optical disk, ROM, or RAM. Such computer programs may also be received via network interface 2250 or serial port interface 2242. Such computer programs, when executed or loaded by an application, enable computer 2200 to implement features of embodiments of the present invention discussed herein. Accordingly, such computer programs represent controllers of the computer 2200.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### IV. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method, comprising:
invoking a local transaction scope that includes a plurality of transaction operations and a commit operation, said invoking the local transaction scope causing a local transaction object to be generated, the local transaction object including an initial state and a transaction identifier;
generating a request message that includes a first transaction operation of the local transaction scope;
generating an identification number;
initializing the transaction identifier with the identification number;
including the transaction identifier in the request message;
transmitting the request message over a communication channel to a web service to be provided to a line of business (LOB) system;
receiving a response message to the request message from the communication channel, the response message including the transaction identifier; and
changing the initial state of the local transaction object to an active state.

2. The method of claim 1, further comprising:
transmitting at least one additional request message over the communication channel to the web service to be provided to the LOB system, the at least one additional request message including a corresponding next transaction operation of the local transaction scope and including the transaction identifier; and
receiving at least one additional response message from over the communication channel corresponding to the at least one additional request message.

3. The method of claim 2, further comprising:
generating a completion protocol message that includes the transaction identifier and a commit instruction or an abort instruction;
transmitting the completion protocol message to the web service; and
receiving a completion type response message to the completion protocol message.

4. The method of claim 3, wherein said generating a completion protocol message that includes the transaction identifier and a commit instruction or an abort instruction comprises:
including the abort instruction in the completion indication if at least one of the response messages indicates a failure to perform the transaction operation included in the corresponding one of the request messages; and
including the commit instruction in the completion message if none of the response messages indicates a failure to perform the transaction operation included in the corresponding one of the request messages.

5. The method of claim 1, wherein said including the transaction identifier in the request message comprises:
generating a message header that includes the transaction identifier; and
including the generated message header with the request message.

6. The method of claim 1, wherein said transmitting the request message over a communication channel to a web service to be provided to a line of business (LOB) system comprises:
transmitting the request message from a client-side channel interface through a network to a service-side channel interface.

7. A method, comprising:
receiving a request message from a client over a communication channel, the request message including a transaction identifier and a first transaction operation of a plurality of transaction operations of a local transaction scope;
generating a service-side local transaction object that includes the transaction identifier;
providing the first transaction operation to a line of business (LOB) system;
receiving a response indication to the first transaction operation from the LOB system;
changing a state of the local transaction object to an active state; and
transmitting a response message to the client over the communication channel that includes the response indication and the transaction identifier.

8. The method of claim 7, further comprising:
receiving at least one additional request message from the client, the at least one additional request message including a corresponding next transaction operation of the local transaction scope to be provided to the LOB system and the transaction identifier;
providing each next transaction operation to the LOB system; and
transmitting an additional response message corresponding to each next transaction operation to the client.

9. The method of claim 8, further comprising:
receiving a completion protocol message from the client that includes the transaction identifier and a commit instruction or an abort instruction;
completing the local transaction object in response to the completion protocol indication;
instructing the LOB system to perform the received commit instruction or abort instruction;
receiving a completion type indication from the LOB system; and
transmitting a completion type response message in response to the completion protocol message to the client.

10. The method of claim 9, wherein said transmitting a completion type response message in response to the completion protocol message to the client comprises:
including an in doubt indication in the completion type response message if said completing the local transaction object in response to the completion protocol indication fails.

11. The method of claim 7, wherein said generating a service-side local transaction object that includes the transaction identifier comprises:
extracting the transaction identifier from a message header of the request message.

12. The method of claim 8, further comprising:
determining that a response indication received from the LOB system indicates that a corresponding transaction operation failed;
transmitting an abort instruction to the LOB system; and
including an abort indication in the response message corresponding to the failed transaction operation.

13. A client-side system, comprising:
a local transaction scope configured to be invoked by a client that includes a plurality of transaction operations and a commit operation, the local transaction scope causing a local transaction object to be generated, the local transaction object including an initial state and a transaction identifier, the local transaction scope being configured to generate a request message that includes a first transaction operation of the local transaction scope; and
a client-side channel interface configured to generate an identification number, to initialize the transaction identifier with the identification number, to include the transaction identifier in the request message, and to transmit the request message over a communication channel to a web service to be provided to a line of business (LOB) system;
the client-side channel interface being further configured to receive a response message to the request message from the communication channel, the response message including the transaction identifier, and the client-side channel interface being further configured to change the initial state of the local transaction object to an active state.

14. The client-side system of claim 13, wherein the client-side channel interface is configured to transmit at least one additional request message over the communication channel to the web service to be provided to the LOB system, the at least one additional request message including a corresponding next transaction operation of the local transaction scope and including the transaction identifier; and
the client-side channel interface being further configured to receive at least one additional response message from over the communication channel corresponding to the at least one additional request message.

15. The client-side system of claim 14, the client-side system being further configured to generate a completion protocol message that includes the transaction identifier and a commit instruction or an abort instruction, and to transmit the completion protocol message to the web service; and
the client-side channel interface being further configured to receive a completion type response message to the completion protocol message.

16. The client-side system of claim 15, wherein the abort instruction is included in the completion indication if at least one of the response messages indicates a failure to perform the transaction operation included in the corresponding one of the request messages, and the commit instruction is included in the completion message if none of the response messages indicates a failure to perform the transaction operation included in the corresponding one of the request messages.

17. The client-side system of claim 13, wherein the client-side channel interface is configured to generate a message header that includes the transaction identifier, and to include the generated message header in the request message.

18. The client-side system of claim 13, wherein the client-side channel interface is configured to transmit the request message through a network included in the communication channel to a service-side channel interface at the web service.

19. A service-side system, comprising:
a service-side channel interface configured to receive a request message from a client, the request message including a transaction identifier and a first transaction operation of plurality of transaction operations of a local transaction scope, the service-side channel interface being further configured to generate a service-side local transaction object that includes the transaction identifier; and
a line of business (LOB) adaptor configured to provide the first transaction operation to a LOB system, and to receive a response indication to the first transaction operation from the LOB system;
the service-side channel interface being further configured to change a state of the local transaction object to an active state, and to transmit a response message to the client that includes the response indication and the transaction identifier;
the service-side channel interface being further configured to receive at least one additional request message from the client, the at least one additional request message including a corresponding next transaction operation of the local transaction scope to be provided to the LOB system and the transaction identifier;
the LOB interface being configured to provide each next transaction operation to the LOB system; and
the service-side channel interface being configured to transmit an additional response message corresponding to each next transaction operation to the client.

20. The service-side system of claim 19, wherein the service-side channel interface is configured to receive a completion protocol message from the client that includes the transaction identifier and a commit instruction or an abort instruction, and to complete the local transaction object in response to the completion protocol indication;
the LOB interface being further configured to instruct the LOB system to perform the received commit instruction or abort instruction, and to receive a completion type indication from the LOB system; and
the service-side channel interface being configured to transmit a completion type response message in response to the completion protocol message to the client.
